(19) United States
(12) Patent Application Publication
(10) Pub. No.: US 2012/0058248 A1
(43) Pub. Date: Mar. 8, 2012

(54) SYSTEMS AND METHODS FOR REDUCING ALGAL BIOMASS

(75) Inventors: David Stephen, Davis, CA (US); Gaye Elizabeth Morgenthaler, Woodside, CA (US); Benjamin Chiau-Pin Wu, San Ramon, CA (US); David Vancott Jones, Woodside, CA (US)

(73) Assignee: LiveFuels, Inc., San Carlos, CA (US)

(21) Appl. No.: 13/140,407

(22) PCT Filed: Dec. 16, 2009
(86) PCT No.: PCT/US09/68205

§ 371 Date: Nov. 21, 2011

Related U.S. Application Data
(60) Provisional application No. 61/138,464, filed on Dec. 17, 2008.

(51) Int. Cl. C02F 3/32; A01K 61/02; A01K 63/00; C11B 1/08; A01K 61/00; C10L 1/18; C11B 1/06; A23L 1/326; A01K 63/04

(52) U.S. Cl. 426/665; 119/231; 119/223; 119/226; 119/200; 44/308; 554/8

(57) ABSTRACT

The invention relates to systems and methods for reducing algal biomass in eutrophic water, wherein organism that feed on algae are introduced into the eutrophic water and cultured in the eutrophic water, until the algal biomass is reduced or the organisms have reach desirable size. The body of eutrophic water can be restocked with juveniles after harvesting. The organisms can be fishes and/or shellfishes. The methods further comprising producing biofuel, specialty chemicals, nutraceuticals, food, and/or fish meal from the harvested fish.

The application claims the benefit of U.S. Provisional Patent Application Ser. No. 61/138,464, filed Dec. 17, 2008, which is incorporated by reference herein in its entirety.

### 1. INTRODUCTION

The invention relates to systems and methods for reducing algal biomass in nutrient-rich water.

### 2. BACKGROUND OF THE INVENTION

The lake and coastal regions of many parts of the world are economically vital areas supporting large population centers and a diverse range of businesses and industries. There is also an increase in recreational use of these bodies of water reflecting a demand on high environmental qualities of these regions. However, these regions face a variety of environmental problems, including degraded water resources, toxic contamination, and shoreline erosion. One of the most important problems is nutrient over-enrichment. Recent coastal surveys of Unites States and Europe found that 78% of the assessed continental US coasts and 65% of Europe's Atlantic coast exhibit symptoms of nutrient over-enrichment (Bricker et al., 2007, Effects of Nutrient Enrichment in the Nation's Estuaries: A Decade of Change. NOAA Coastal Ocean Program Decision Analysis Series No. 26. Silver Spring, Md., National Centers for Coastal Ocean Science; OSPAR integrated report 2003 on the eutrophication status. OSPAR Commission. 2003. London, U.K).

The major nutrients that cause over-enrichment are nitrogen and phosphorus. The sources of nutrients vary among regions and are very often remote from the body of affected water. Agriculture, human sewage, urban run-off, industrial effluent, and fossil fuel combustions are the most common sources. The intensive use of commercial fertilizers over the last 50 years has increased crop yield but much of the nutrients not absorbed by crops find their way into local rivers and lakes, and are carried downstream to the estuaries, and eventually to the sea. Human activities have resulted in the near doubling of nitrogen and tripling of phosphorus flows to the environment when compared to natural causes. Trends in agricultural practices, energy use, and population growth indicate that eutrophication, especially in coastal areas, will be an ever-growing problem.

Nutrient over-enrichment often leads to algal bloom resulting in changes in biodiversity and loss of habitats (e.g., decline of coral reef), and appearance of “dead zones” where most animals are driven away or die of hypoxia. Change in abundance and diversity of living organisms have adverse impacts on the environmental quality of lakes and coastal waters. The Gulf of Mexico has a seasonal hypoxic zone that forms every year in late summer. Its size varies, in 2000, it was less than 5,000 km², while in 2002, it was approximately 22,000 km² (or the size of the state of Massachusetts). Of the 415 areas around the world identified as experiencing some form of eutrophication, 169 are hypoxic (Selman et al., Eutrophication and hypoxia in coastal areas: a global assessment of the state of knowledge, World Resource Institute Policy Note, March 2008).

A common symptom of nutrient over-enrichment is the excessive production of algal biomass. Where excess algal proliferation is dominated by certain species of toxic algae, mass mortalities of wild fish and shellfish, birds and even mammals occur; fish farms that use these waters are also impacted. Paralysis, diarrhea, and amnesia were associated with human consumption of contaminated seafood. In 1997, hundreds of dead fish were found in Chesapeake Bay and Pokomoke River near Maryland in the United States, resulting in waterway closures and public rejection of aquatic produce from the area. The economic loss suffered by the local seafood industry was estimated to be US$43 million (Lipton, D. W., 1998, Pfiesteria's economic impact on seafood industry sales and recreational fishing. Pfiesteria: where do we go from here? Economics of Policy Options for Nutrient Management and Dinoflagellates Conference. University of Maryland, Department of Agriculture and Natural Resources, College Park). In 1998, an algal bloom wiped out 90 percent of the entire stock of Hong Kong's fish farms and resulted in an estimated economic loss of US$40 million (Lu, S., and I. J. Hodgkiss, 2004, “Harmful algal bloom causative collected from Hong Kong waters.” Hydrobiologia 512(1-3): 231-238).

In 2008, nearly half of the world's population lives within 60 kilometers of the coast, with many communities relying directly on coastal ecosystems for their livelihoods. This means that a significant portion of the world's population is vulnerable to the effects of nutrient enrichment in their local aquatic ecosystems. Nutrients from point sources are relatively easy to minimize with wastewater treatment processes. Nutrients from non-point sources, such as large watersheds with extensive agricultural activities, are much harder to control. Regulatory efforts such as the United States Federal Clean Water Act have been helpful in curtailing anthropogenic nutrient loading. However, besides reducing nutrient load, there is an urgent need to abate the deterioration of the quality of water in the world's lakes and coastal regions. The present invention provides systems and methods for reducing algal biomass in nutrient-enriched water.

Citation of any reference in Section 2 of this application is not to be construed as an admission that such reference is prior art to the present application.

### 3. SUMMARY OF THE INVENTION

The invention provides biological methods for reducing algal biomass in a body of eutrophic water comprising culturing organisms that feed on the algae in the water, preferably in an enclosure. The invention can be used to prevent algal overgrowth, prevent the occurrence of an algal bloom including a harmful algal bloom or a hypoxic zone. The invention can also be used to reduce the algal biomass in a pre-existing algal bloom, harmful algal bloom, or hypoxic zone. The invention can also be used to prevent or reduce the loss of seagrasses and/or perennial benthic macroalgae in an aquatic area. The organisms used in the invention are fishes and/or shellfishes.

The invention can be used in eutrophic water found inland or in coastal areas, including but not limited to lake, river estuary, continental shelf, lagoon, drowned river bed, embayment, gulf, and coastal plain. Typically, the source of the nutrients in eutrophic water is agricultural runoff, industrial effluent, sewage, upwelling, aquaculture waste, or a mixture thereof. The oversupply of nutrients in a body of eutrophic water support algal growth leading to an increase in algae biomass, an algal bloom, a harmful algal bloom, or hypoxia. In certain embodiments, the growth rate of the algae in eutrophic water is limited by the concentration of at least one of these elements: nitrogen, phosphorous, iron, or silicon.

Eutrophic water and algal bloom can be identified by one or more techniques, such as but not limited to analysis of water samples and remote sensing. Optionally, the data can be analyzed in combination with historical data for a region. For example, eutrophic water can be found in a location where an algal bloom has occurred previously or occurs on a regular, diurnal, seasonal, or annual basis.

A community of different algae comprising microalgae such as raphidophytes, dinoflagellates, diatoms, and/or cyanobacteria are commonly found in eutrophic water. In an algal bloom, bloom species belonging to the following taxonomic groups are found: Anabaena, Aphanizomenon, Microcystis, Noctiluca, Alexandrium, Prorocentrum, Gymnodinium, Ceratium, Pfiesteria, Dinophysis, Gyrodinium, Heterosigma, Chattonella, Skeletonema, Synedropsis, Pseudonitzschia, Leptocylindrus, Chaetoceros; Phaeocystis, Nannochloris, Stichococcus, Aureococcus, Miraltia, Guinardia, Spermatozopsis, Urosolenia, Nitschia, Cyclotella, Cryptomonas, and Pedinophora. The sizes of the algae including bloom species can range from about 20-200 μm, about 2-20 μm, or about 0.2-2 μm.

Depending on the bloom species and water conditions, such as turbidity, dissolved oxygen level and toxin level, the invention contemplates using fishes and/or shellfishes of various sizes, ages, or developmental forms to feed on the algae. Planktivorous organisms that have developed specialized structures (e.g., gill rakers in fish such as menhaden, or gill lamellae in bivalves such as green mussels) to feed on plankton, phytoplankton in particular, are preferred. The planktivorous organisms in the enclosure can be chosen for their preference for plankton of a particular size range that matches the size of the bloom species. As the composition and size distribution of the plankton community in a bloom changes over time, a different assemblage of planktivorous organisms with appropriately matching preferences of food size or type can be used.

In preferred embodiments, the planktivorous organisms are fishes of the order Clupiformes, which include but is not limited to, menhaden, anchovies, shads, sardines, pilchards, herring, and hilsas. Preferably, gulf menhaden or Atlantic menhaden are used in the Gulf of Mexico and east coasts of North America respectively. The shellfishes used in the methods of the invention are preferably bivalves, such as but not limited to oysters, mussels, scallops, and clams. Depending on the local environment, marine, brackish, and/or freshwater species can be used. The fishes and shellfishes are cultured within the enclosure of the invention until the algal biomass is reduced or when the fishes and shellfishes have grown to a certain size suitable for harvesting and processing. The enclosure can be restocked with juveniles of the organisms after harvesting. The planktivorous organisms are harvested or gathered and processed by methods known in the art for seafood processing and rendering of fish meal and fish oil. The fish oil can be used as an energy feedstock. Other uses include production of specialty chemicals and nutraceuticals. Shellfishes can be harvested for human consumption. Methods for making biofuel from fishes grown in enclosures and harvested from the eutrophic water, are aspects of the invention.

In various embodiments, the invention is used in a location where the water conditions are favorable for development of an algal bloom, or an algal bloom is developing. The invention can be practiced by towing a mobile enclosure to and mooring it at or near, a location with an algal bloom and/or hypoxic zone. To deploy the invention in a body of eutrophic water, the planktivorous organisms are introduced into an enclosure situated in the body of water. The invention can be deployed just before the start of a regular algal bloom, or after a bloom has developed. By manipulating the timing of sexual maturation, mating, and spawning of stocks, planktivorous organisms of a certain age or developmental stage can be produced for use in the enclosure at any time during the year. In various embodiments, the planktivorous organisms of the invention are confined so that they can be harvested from the water easily without permanently altering the local trophic system. Also encompassed are systems for culturing, transporting, and processing of planktivorous organisms of the invention. The enclosures of the invention are artificial structures that confine the planktivorous organisms in an eutrophic zone, such as but not limited to cages and nets as well as, solid substrates to which shellfishes attached themselves. The enclosure can be floating, submersible, or entirely underwater, and can be installed as a group in an area. In certain embodiments of the invention, the enclosures are not permanently installed and can be relocated to another geographic location. In one embodiment, the enclosure is a towage cage or net in which the planktivorous organisms are cultured. Non-limiting examples of an enclosure include a modified vessel or a modified oil/gas production platform.

### 4. BRIEF DESCRIPTION OF THE DRAWING

FIG. 1 shows a framework for the application of planktivorous-trophic level bioremediation technology. Box 1 indicates an embodiment of the invention directed to reducing algal biomass in eutrophic coastal waters (marine and brackish ecosystems). Box 2 indicates an embodiment of the invention that is applicable to inland waters. Box 3 indicates an embodiment of the invention useful for reducing algal biomass in waste water discharged from, for example, industrial plants, animal husbandry operations, or fish farms.

### 5. DETAILED DESCRIPTION OF THE INVENTION

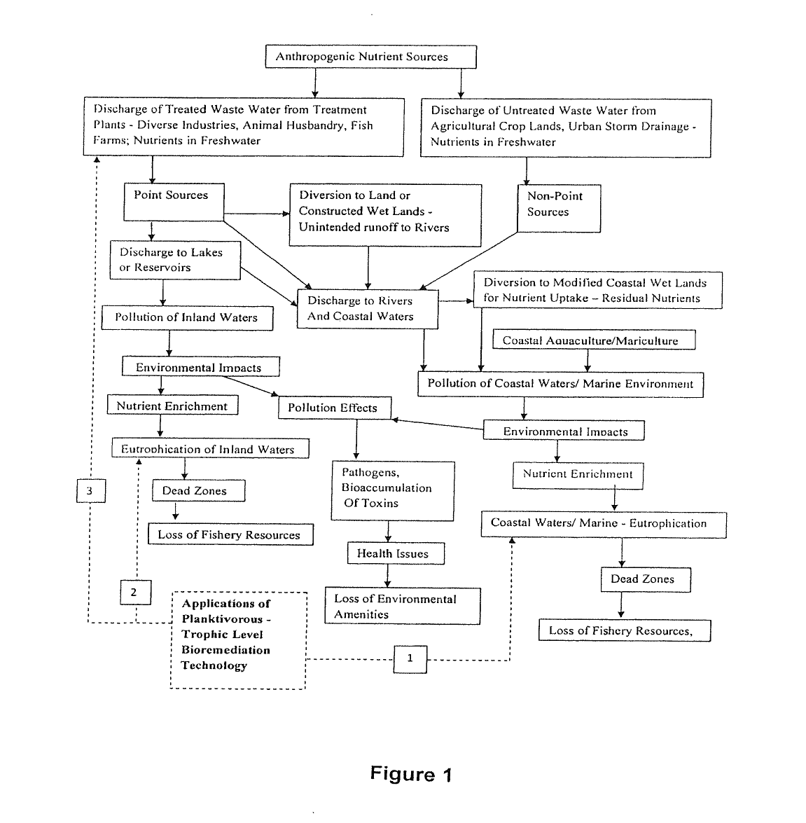

The over-enrichment of water by nutrients, referred to herein as “eutrophication” degrades many aquatic ecosystems worldwide. The current conceptual model of eutrophication recognizes an interacting set of direct and indirect responses of an aquatic ecosystem to nutrient enrichment. Nutrient input stimulates accumulation of phytoplankton biomass, followed by vertical flow of algal-derived organic matter to bottom waters and the sediments, decomposition of the organic matter by bacteria which use up the available dissolved oxygen. Indirectly, eutrophication affects water transparency, distribution of vascular plants and biomass of macroalgae, nutrient cycling, nutrient ratios, plankton community composition, frequency of toxic/harmful algal blooms, habitat quality for metazoans, and reproduction/growth/survival of pelagic and benthic invertebrates. (2001, Cloern, Our evolving conceptual model of the coastal eutrophication problem, Mar Ecol Prog Ser 210:223-253). FIG. 1 shows some of the events that lead to loss of fishery resources and environmental amenities, starting from anthropogenic activities that produce nutrients, eutrophication, and the development of dead zones. The inventors believe that an understanding of the relationships of various elements in an eutrophic system offers the possibility of intervention with a view towards abating the deleterious effects of eutrophication.

The invention relates to planktivorous-trophic level bioremediation technology for reducing algal biomass in eutrophic water. The methods of the invention employ organisms of various trophic levels to consume algae in waters rich in nutrients. Primarily, the organisms are planktivores that occupy the second trophic level, and feed on organisms in the first level that are mostly phytoplankton. When algal blooms occur in natural water bodies, there is a trophic-level association of diverse animal forms, between invertebrate zooplankton and fishes that consume algae and higher invertebrates, and vertebrates that feed on the zooplankton and smaller species of vertebrates. Within this trophic system, there is a balance in population between the feeding groups that is driven by algal productivity. Nutrient loading causes algal productivity to proceed at rates that are many orders of magnitude higher than consumption by animal forms. Zooplankton blooms generally follow the peak in phytoplankton blooms which begin to diminish due to overgrazing or nutrient depletion. The invention takes into account these relationships in population dynamics of blooms and bloom induced trophic associations.

The invention is based in part on the recognition that the presence of an assemblage of organisms that feed on algae in eutrophic water can be used to counter an increase in algae population by the effect of grazing or foraging. The inventors believe that algae can be removed efficiently by the organisms provided that they are deployed and allowed to feed in eutrophic water where the oxygen level is not limiting for the organisms, and the level of algal toxin, if present, does not significantly harm the organisms. According to the invention, when a developing algal bloom is detected in a body of eutrophic water, organisms that feed on algae are delivered or introduced to the eutrophic water where the algae are growing rapidly. Both fishes and shellfishes can be used in the invention. The organisms are cultured in the eutrophic water so that the organisms can consume the algae, thereby reducing the algal biomass. The culture can be maintained until either the algal biomass is reduced to a desired level, or the organisms have grown to a desirable size and are ready to be harvested. The body of eutrophic water can be restocked with the organisms, including juveniles of the organisms, to begin another round of introducing the organisms and culturing. The steps of introducing, culturing and harvesting the organisms in the eutrophic water can be conducted repeatedly for multiple rounds (e.g., at least one round), or for as long as the need to reduce algal biomass exists. The invention also provides that fishes that are fed on algae can be used as food fish, and to make biofuel, industrial feedstock, or aquaculture feed. The shellfishes of the invention can be sold for human consumption or rendered. The invention also pertains to the use of tertiary consumers of planktivorous organisms (predators or piscivores) to facilitate easier and cost effective harvesting of the algae bloom indirectly. The high market value of predatory fishes, such as but not limited to tuna, marlins, and groupers, provides an additional revenue stream to support the operation.

The invention is supported by the observation that benthic bivalve filter feeders play the role of a biological, locale-specific attribute which modulates the response of an estuarine-coastal ecosystem to nutrient enrichment, leading to large differences among such ecosystems in their sensitivity to nutrients. For example, one of the better predictor of chlorophyll a (chl a) concentration in Danish estuaries, a measure of algal biomass concentration, is the biomass of mussels. Another example shows that the balance between phytoplankton production and loss to benthic feeders can be disrupted by the colonization of an ecosystem by non-indigenous suspension feeders. This occurred in northern San Francisco Bay when the Asian clam Potamocorbula amurensis became widely established in 1987; and since then, chlorophyll biomass has been persistently low and primary production has been reduced 5-fold (Alpine & Cloern, 1992, Trophic interactions and direct physical effects control phytoplankton biomass and production in an estuary, Limnol. Oceanogr. 37:946-955). These phenomena occur where there is an interaction between the pelagic and benthic zones involving a large number of benthic bivalve suspension feeders removing phytoplankton from the water.

In various embodiments of the invention, the fishes and shellfishes introduced into a body of eutrophic water are confined to the systems of the invention. Such systems comprise an enclosure, including a substrate, positioned in the eutrophic water. Enclosures for shellfishes do not necessarily envelope the shellfishes since they are physically attached to the enclosures. Optionally, the fishes and shellfishes are held in enclosures that can be relocated from one geographic location to another. The culturing of the fishes and shellfishes in the eutrophic water can entail replenishing the eutrophic water in or near the enclosure with algae; and/or maintaining the level of dissolved oxygen in the eutrophic water in or near the enclosure above hypoxic level (such as about 3 mg per liter). The methods can comprise mixing eutrophic water from outside or a distance from the enclosure with the eutrophic water in or near the enclosure, continuously or periodically. The mixing can serve the purpose of replacing the algae consumed, facilitating gaseous exchange, diluting of algal toxin, and removal of waste produced by the organisms. Various techniques for mixing water within an area in a lake or a coastal area are known and can be applied in the methods of the invention. In many embodiments of the invention, the culturing methods do not comprise adding fish meal, fish oil, nitrogenous fertilizer, and/or phosphorous fertilizer into the eutrophic water.

In one embodiment of the invention, the methods can be initiated by installing an enclosure in an eutrophic zone, such as locations that are prone to formation of harmful algal bloom and/or hypoxic zone. As the algal biomass is accumulating, organisms that feed on the algae are introduced into the enclosure. Alternatively, the enclosure (including a substrate for shellfish) is designed to be transportable, and is relocated to where algal biomass is accumulating. Different species of fishes and shellfishes at various ages or developmental forms can be used in combination or in sequence to remove algae from eutrophic water. An advantage of the present invention is the flexibility of its deployment in almost any location where there is a body of eutrophic water and at any time of the year. Because the fishes and shellfishes are confined to the systems of the invention in certain embodiments, they can be readily removed from the eutrophic water. Thus, the presence of the fishes and shellfishes of the invention in an eutrophic zone is not necessarily persistent. Methods for maintaining stock in an artificial environment, adapted to producing organisms of the appropriate age or developmental stage year round for use in the invention, are also parts of the invention.

The invention also combines the use of remote sensing and water sampling technologies to identify eutrophic zones so that algal overgrowth in the eutrophic zones can be controlled before it develops into harmful algal bloom (HAB) or leads to hypoxia. The systems of the invention optionally include data systems that comprise remote sensing and water sampling subsystems, data integration and modeling subsystems; stationary or mobile enclosures for rearing planktivorous organisms; guidance system for steering mobile enclosures; assemblages of fishes and shellfishes that are active at multiple trophic levels; fish gathering equipment; and fish oil/fish meal processing facilities.

The present invention is different from the practice of biomanipulation in small shallow lakes which calls for the specific removal of zooplanktivorous fishes from the lakes through predation by piscivores. The population of planktivorous shellfish of the present invention is distinguishable from the naturally occurring benthic bivalves because the shellfish of the invention are cultured on an artificial substrate that can be moved horizontally along a river or a coastal region as well as vertically at various depths in a water column, depending on the amount of algal biomass and the conditions of the water (e.g., level of dissolved oxygen).

The primary nutrients responsible for eutrophication are nitrogen and phosphorous, although other nutrients, such as iron and silicates, are also implicated. Whether primary production by phytoplankton is nitrogen or phosphorous limited is a function of the relative availabilities of the two elements in water. Phytoplankton require approximately 16 moles of nitrogen for every mole of phosphorous they assimilate, i.e., the Redfield ratio of 16:1, (Refield, 1958, American Scientist, 46:205-222). If the Redfield ratio is less than 16:1, phytoplankton growth will tend to be limited by nitrogen. If the ratio is higher, phytoplankton growth will tend to be phosphorous limited. It has been observed that nitrogen limitation is more prevalent in coastal marine ecosystems than in lakes.

The methods of the invention are applicable to bodies of water that is either nitrogen limited or phosphorous limited, including both inland waters, coastal waters, as well as discharged waste water. The source of waste water can be but not limited to urban/municipal wastewater treatment facilities, industrial effluents, animal farm operations, or aquaculture operations. Preferably, the waste water has been treated to remove most of the toxic chemicals and pathogenic microorganisms. FIG. 1 shows where the systems and methods of the invention can be applied to prevent and/or remediate damages caused by the overgrowth of algae. To avoid duplicate descriptions, the invention will be described mostly in the context of coastal waters without limiting the invention to only uses in coastal waters. It should be understood that the systems and methods of the invention are similarly applicable to inland waters, such as rivers, ponds and lakes, and waste water, unless specified otherwise.

The term “coast” includes all areas between land and ocean, such as but not limited to, beaches, estuaries, marine habitats along the shore, as well as the shallow coastal ocean just offshore. A coast can be more specifically classified as open continental shelf (e.g., Georgia Bight, Monterey Bay, Louisiana Shelf), coastal embayment (e.g., Massachusetts Bay, Buzzards Bay, Long Island Sound), river plume estuary (e.g., Mississippi River Plume), coastal plain or drowned river valley estuary (e.g., Chesapeake Bay, Hudson River, Charleston Harbor, Choctawhatchee Bay, Perdido Bay, Apalachee Bay), coastal plain salt marsh estuary (e.g., Plum Island Sound, North Inlet, Duplin River, Pensacola Bay), lagoon (e.g., Padre Island, Pamlico Sound, Apalachicola Bay), fjord estuary (e.g., Penobscot Bay), coral reef system (e.g., Kaneohe Bay), tectonically-caused estuary (e.g., San Francisco Bay, Tomales Bay), large river with non-drowned river estuary (e.g., Columbia River), seagrass-dominated estuary (e.g., Tampa Bay, lower Perdido Bay), rocky-intertidal macroalgae dominated estuary (e.g., Casco Bay). It is contemplated that the systems and methods of the invention can be used in the named exemplary coastal systems in the United States as well as those with similar physiographic characteristics worldwide. Exemplary areas where algal blooms and hypoxic zone appear regularly include but are not limited to, Kattegat near Sweden and Denmark, Baltic Sea, Bohai Sea, Taihu (or Lake Tai), and Black Sea.

For clarity of disclosure, and not by way of limitation, the detailed description of the invention is divided into the subsections which follow.

### 5.1. ECOLOGICAL EFFECTS OF EUTROPHICATION

The terms “eutrophic” and “eutrophication” are used herein to describe the presence of an abundance of nutrients in a body of water, i.e., nutrient enrichment. For many aquatic ecosystems, primary productivity is limited by nutrient availability. Therefore, a direct response to nutrient input in these ecosystems is an increase in phytoplankton biomass, leading to the formation of an algal bloom. A body of water with productivity greater than about 300 g C m⁻² year⁻¹ and exhibits at least one of the following characteristics is referred to as a body of eutrophic water, that forms an eutrophic zone in a body of water. Some of the characteristics of eutrophic water, relative to non-eutrophic water (i.e., exhibiting productivity less than 300 g C m⁻² year⁻¹) include but are not limited to, increased phytoplankton productivity, high chlorophyll a concentration, decreased light availability to benthic zone, high epiphytic growth rate, high non-perennial macroalgae growth rate, changes in dominance from benthic algae to pelagic algae, and a shift in dominance from diatoms to dinoflagellates. The body of water that becomes eutrophic can range from about 10, 50, 100, 200, 500 and up to 1000 m², or from about 1, 2, 5, 10, 20, 50, 100, 200, and up to 500 km². The invention can be used to reverse at least some of the changes observed in the aquatic environment that results from eutrophication.

Many coastal waters are shallow enough that benthic plant communities thrive where sufficient light penetrates the water column to the seafloor. Benthic vascular plants (seagrasses) and perennial macroalgae are more adapted to low nutrient environments than phytoplanktons and ephemeral macroalgae. An increase in nutrient input results in the progressive selection for fast-growing algae that are best adapted to high-nutrient conditions, at the expense of slower-growing seagrasses and perennial macroalgae. Phytoplankton biomass can reduce light penetration and epiphytic microalgae becomes more abundant on seagrass leaves in eutrophic water contributing to light attenuation. Ephemeral macroalgae, such as Ulva, Caldophora, and Chaetomorpha, can form extensive thick mats over the seagrass leading to its disappearance from the seafloor. Loss of benthic seagrasses and macroalgae will result in changes in the associated fauna, and increases sediment resuspension that causes influx of nutrients from the sediment further promoting algal blooms. The accumulation of ephemeral macroalgae is a nuisance to recreational users of beaches and waterways. The invention can be used to prevent or reduce the loss of seagrasses and perennial macroalgae by reducing the phytoplankton biomass.

Plankton species have a wide range of nutrient requirements and the plankton community composition of a coastal region can be directly changed by eutrophication. A limitation of silicates in the water restricts the growth of diatoms and/or the amount of silicon in their bodies. It has been observed that as the size of the diatom population in a water column falls, an increase in the number of flagellates is detected. Among the many species of algae that thrives in a body of water, some can produce toxins that are harmful to other organisms that either ingest these species or share the same aquatic environment. For example, the species Chaetoceros has been associated with the deaths of farmed salmon, they have long, barbed spines that lodge in fish gills, causing a buildup of mucus, degeneration of the respiratory system, and eventual death by suffocation. Some species interfere with fish reproduction. When one or more species of algae that can produce toxins or cause harm to other marine life and humans, proliferate and become numerically dominant in an eutrophic zone, a harmful algal bloom (HAB) is formed. The invention can be used to prevent the formation of a harmful algal bloom or to reduce the algal biomass in a harmful algal bloom.

Eutrophication is also accompanied by an increased demand for oxygen, due in part to respiration of the increased biomass of plants and animals in the nutrient-loaded system, but mostly to respiration of bacteria in the water column and sediments that consume the organic matter produced by or resulting from death of, the plant and animal biomass. If the loss of oxygen is not offset by the introduction of additional oxygen by photosynthesis or mixing, then hypoxia or anoxia occurs. Dissolved oxygen less than about 2.0 to 3.0 mg per liter is referred to herein as hypoxia. Anoxia is a form of hypoxia when biologically useable dissolved oxygen is completely absent. Hypoxia and anoxia are more likely to occur in warmer months because of thermal stratification of the water body that prevents mixing of oxygen-rich surface water with bottom water. The occurrence of areas of hypoxia near the coasts can kill marine life, disrupt their migration and habitat, and change the benthic community structure. The invention can be used to prevent hypoxia in an eutrophic zone, which includes removing algal biomass in the body of water that lies above the hypoxic zone.

### 5.2 ALGAL BLOOM

As used herein the term “algae” refers to any organisms with chlorophyll and a thallus not differentiated into roots, stems and leaves, and encompasses prokaryotic and eukaryotic organisms that are photoautotrophic or photoauxotrophic. The term “algae” includes macroalgae (commonly known as seaweed) and microalgae. For certain embodiments of the invention, algae that are not macroalgae are preferred. The terms “microalgae” and “phytoplankton,” used interchangeably herein, refer to any microscopic algae, photoautotrophic or photoauxotrophic eukaryotes (such as, protozoa), photoautotrophic or photoauxotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that comprises algae, such as an aquatic composition, and is not limited to a body of water within an area, or a sample of a body of water. The microalgae of the invention are also encompassed by the term “plankton” which includes phytoplankton, zooplankton and bacterioplankton. It is contemplated that many aspects of the invention can be practiced with a planktonic composition, without isolation of phytoplankton, or removal of the zooplankton or other non-algal planktonic organisms.

The composition and numbers of phytoplankton communities depend on a balance of local factors. Phytoplankton inhabit all types of aquatic environment, including but not limited to freshwater (less than about 0.5 parts per thousand (ppt) salts), brackish (about 0.5 to about 31 ppt salts), marine (about 31 to about 38 ppt salts), and briny (greater than about 38 ppt salts) environment. Field observations indicate the distribution of sizes of a phytoplankton community often varies with resource availability and hydrographic conditions. It has been observed generally that small phytoplankton are dominant under oligotrophic conditions, and large phytoplankton are more abundant in eutrophic water. The methods of the invention can be used to remove plankton, phytoplankton and/or zooplankton, of various sizes, ranging in dimensions from about 200 to 2000 μm, about 20 to 200 μm, about 2 to 20 μm, or about 0.2 to 2 μm.

Algal species can be identified by microscopy and enumerated by counting or flow cytometry, which are techniques well known in the art. Chlorophyll a is a commonly used indicator of algal biomass. However, it is subjected to variability of cellular chlorophyll content (0.1 to 9.7% of fresh algal weight) depending on algal species. The estimated biomass value can be calibrated based on the chlorophyll a content of the dominant species within a population. Published correlation of chlorophyll a concentration and biomass value can be used in the invention. Chlorophyll a concentration is to be measured within the euphotic zone. The euphotic zone is the depth at which the light intensity of the photosynthetically active spectrum (400-700 nm) equals 1% of the subsurface light intensity.

Nutrient over-enrichment destabilizes plankton populations by allowing certain species to compete successfully against all other species present. Apparently, initiation of an algal bloom (including a harmful algal bloom) is dependent on a series of events or a set of optimal conditions. Thus, a bloom can be circumvented by disrupting at least one event in the sequence, or altering the optimal conditions. A body of eutrophic water comprising more than about 1×10⁵ algal cells per ml can develop a bloom under certain conditions. For example, the body of eutrophic water can comprise more than about 2×10⁵, about 5×10⁵, about 8×10⁵ algal cells per ml. The term “algal bloom” as used herein refers to the presence of algae in a body of water comprising at least about 1×10⁶ algal cells per ml or greater, such as but not limited to about 5×10⁶ algal cells per ml, about 10⁷ algal cells per ml, about 5×10⁷ algal cells per ml, and about 10⁸ algal cells per ml.

An algal bloom comprises one or several numerically dominant species of algae. Dominant species in an algal bloom is referred to as a bloom species. A dominant species is one that proliferates and thus ranks high in the number of algal cells, e.g., the top one to five species with the highest number of cells relative to other species. The one or several dominant algae species may constitute greater than about 10%, about 20%, about 30%, about 40%, about 50%, about 60%, about 70%, about 80%, about 90%, about 95%, about 97%, about 98% of the algae present in the culture. In certain embodiments, several dominant algae species may each independently constitute greater than about 10%, about 20%, about 30%, about 40%, about 50%, about 60%, about 70%, about 80% or about 90% of the algae present in the culture. Many other minor species of algae may also be present in such culture but they may constitute in aggregate less than about 50%, about 40%, about 30%, about 20%, about 10%, or about 5% of the algae present. In various embodiments, one, two, three, four, or five dominant species of algae are present in a body of eutrophic water or in a bloom. Accordingly, a body of eutrophic water comprising algae or an algae bloom can be described and distinguished from another body of water or bloom by the dominant species of algae present. The population of algae present in a body of eutrophic water can be described by the percentages of cells that are of dominant species relative to minor species, or the percentages of each of the dominant species.

In the context of coastal systems, of the estimated total number of marine phytoplankton (about 5000), some 300 species are known to occur at numbers high enough to discolor water (Sournia et al., 1991, J Plankton Res 13; 1093-1099). About 40 to 50 of these species produce toxins that can affect marine plants and animals (Hallegraeff, 1995, Manual on harmful Marine Microalgae, IOC manual and guides 33. UNESCO, Paris). The algal species that discolor water or produce harmful effects described in the above references can be removed from water by the methods of the invention. Specific examples of such algal species are described below.

In various embodiments, one or more species of algae belonging to the following phyla can be removed by the methods of the invention: Cyanobacteria, Cyanophyta, Prochlorophyta, Rhodophyta, Glaucophyta, Chlorophyta, Dinophyta, Cryptophyta, Chrysophyta, Prymnesiophyta (Haptophyta), Bacillariophyta, Xanthophyta, Eustigmatophyta, Rhaphidophyta, and Phaeophyta. The methods of the invention are most effective at removing algae that are microscopic, including algae in unicellular and colonial forms.

In certain embodiments, the algae in eutrophic water comprises cyanobacteria (also known as blue-green algae) from one or more of the following taxonomic groups: Chroococcales, Nostocales, Oscillatoriales, Pseudanabaenales, Synechococcales, and Synechococcophycideae. Non-limiting examples include Gleocapsa, Pseudoanabaena, Oscillatoria, Microcystis, Synechococcus and Arthrospira species.

In certain embodiments, the algae in eutrophic water comprise algae from one or more of the following taxonomic classes: Euglenophyceae, Dinophyceae, and Ebriophyceae. Non-limiting examples include Euglena species and the freshwater or marine dinoflagellates.

In certain embodiments, the algae in eutrophic water comprise freshwater, brackish, or marine diatoms from one or more of the following taxonomic classes: Bacillariophyceae, Coscinodiscophyceae, and Fragilariophyceae. Preferably, the diatoms are photoautotrophic or auxotrophic. Non-limiting examples include Achnanthes (e.g., A. orientalis), Amphora (e.g., A. coffeiformis strains, A. delicatissima), Amphiprora (e.g., A. hyaline), Amphipleura, Chaetoceros (e.g., C. wighami, C. subtilis, C. affinis, C. muelleri, C. gracilis), Caloneis, Camphylodiscus, Cyclotella (e.g., C. cryptica, C. meneghiniana), Cricosphaera, Cymbella, Diploneis, Entomoneis, Fragilaria, Hantschia, Gyrosigma, Melosira, Navicula (e.g., N. acceptata, N. biskanterae, N. pseudotenelloides, N. saprophila), Nitzschia (e.g., N. dissipata, N. communis, N. inconspicua, N. pusilla strains, N. microcephala, N. intermedia, N. hantzschiana, N. alexandrina, N. quadrangula), Phaeodactylum (e.g., P. tricornutum), Pleurosigma, Pleurochrysis (e.g., P. carterae, P. dentata), Selenastrum, Surirella and Thalassiosira (e.g., T. weissflogii).

The following algae are bloom species that are found in algal bloom, including harmful algal bloom: cyanobacteria (e.g., Anabaena species, Aphanizomenon species, Microcystis species (e.g., M. aeruginosa), Merismopedia tenuissima); dinoflagellates (e.g., Noctiluca scintillans (responsible for red tides in many parts of the world), Alexandrium species (e.g., A. fundyense, A. tamarense, A. monilatum), Prorocentrum species (e.g., P. micans, P. lima, P. minimum, P. triestinum), Gymnodinium species (e.g., G. breve (also known as Karenia brevis commonly found in Florida red tide), G. catenatum, G. mikimotoi), Ceratium species (e.g. C. furca, C. hircus), Karlodinium veneficum, Pfiesteria species (e.g., P. shumwayae, P. piscicida), Amphidinium operculatum, Cochlodinium heterolobatum, Dinophysis sp. (e.g., D. acuminata, D. acuta, D. caudata, D. fortii, D. norvegica), Gyrodinium aureolum, Scrippsiella trochoidea, Akashiwo sanguinea); Raphidophyte (e.g., Heterosigma akashiwo, Chattonella species (e.g., C. verruculosa, C. antique, C. marina), Fibrocapsa japonica); diatoms (e.g., Skeletonema species (e.g., S. costatum, S. potamus), Synedropsis species, Pseudonitzschia species (e.g., P. pseudodelicatissima, P. seriata, P. pungens), Leptocylindrus danicus, Chaetoceros species (e.g., C. curvisetus, C. pseudocurvisetus), Biddulphia sinensis, Eucompia zoodiacus); Haptophytes (e.g, Dictyocha fibula, Phaeocystis species (e.g., P. globosa, P. pouchetii)); brown tide species (Nannochloris atomus, Stichococcus species, Aureococcus anophagefferens) and Protoperidinium brevipes. Additional exemplary species found in algal blooms in the Gulf of Mexico include but are not limited to Miraltia throndsenii, Guinardia delicatula, Spermatozopsis exsultans, Urosolenia eriensis, Nitschia reversa, Cyclotella chocotawhatcheeana, Cryptomonas species, and Pedinophora species.

Powerful remote sensing technologies are available to facilitate detection of algal bloom and identification of eutrophic waters that may develop a bloom. For example, at least four satellites have been commonly used for chlorophyll and phytoplankton mapping: AVHRR, SEAWIFS, LANDSAT and MODIS. Imaging spectrometers (also known as hyperspectral sensors) used in remote sensing simultaneously collect spectral data as both images and as individual spectra. A range of techniques, including fourth-derivative analysis, have been put into operational practice for analysis of algal blooms. For an overview of this technology, see, for example, Remote sensing of algal bloom dynamics by Richardson, L L in Bioscience Vol. 46, no. 7, pp. 492-501. July-August 1996; and US patent publication US 2005/0164333 A1.

In one embodiment of the invention, satellite or aerial remote sensing measurement of ocean color provides complementary data to in-situ water measurements for monitoring algal bloom. It is contemplated that the use of regional reflectance data including analysis of hyperspectral data be incorporated into methods of the invention to assist in locating and identifying algal bloom. Any of numerous algorithms for converting spectral data to algal biomass data can be used.

Radiation leaving a water body is a function of reflection, absorption, and transmission of the optically active constituents in a water body. The reflectance properties of a body of water are typically determined by concentrations of algae and photosynthetic bacteria containing a variety of photosynthetic and photoprotective pigments, such as but not limited to, chlorophyll a, b, and c, generally, gyroxanthin in Karenia brevis, fucoxanthin in Phaeophyceae, and peridinin in dinoflagellates). Chlorophyll a is the primary pigment in phytoplankton that absorbs light for use in photosynthesis. Chlorophyll a absorption peaks in the visible light between 400 and 475 nm and around 665 nm; it reflects most of the light with wavelengths between 475-550 nm. Chlorophyll c, a major secondary pigment, peaks in absorption at 475 and 650 nm, but reflects light from about 500-550 nm. Cyanobacteria is characterized by the presence of cyanophycoerythrin and/or cyanophycocyanin with absorption maxima in the range of 620 to 630 nm. As the individual phytoplankton pigments are characterized by their unique light absorption features, this property allows detection and identification of algal blooms by ocean color spectra. The reflectance spectrum of a body of water consists of overlapping spectral features caused by the presence of individual pigments related to single species and mixtures of species. It has been shown that certain characteristic peaks within the individual pigments can be deconvolved from reflectance spectra, thus allowing mapping of the spatial distribution of specific pigments and give information about the abundance and taxonomic composition of algae.

The systems of the invention comprise data systems which include but are not limited to a measurement device adapted to sense and record and/or transmit the light wavelength reflected from water; a data processing device having programming instructions for applying an algorithm that convert image and/or spectral data into algal biomass data, optionally linked to geographic data; a transmitter for transmitting data from the measuring device or processor to a site remote from the site where the measurement takes place; and a report generator for producing a report of the amounts of algal biomass in the water over an area. Optionally, the data systems of the invention comprise a means for integrating the algal biomass data with historical data and present them on a map for visual inspection and reporting. The data systems of the invention can optionally use the algal biomass data to plot the course of a mobile cage or a vessel towing a cage within a coastal region. The data systems of the invention can optionally generate signals to a guidance system of the invention to steer or change the course of a mobile cage or a vessel towing a cage within a coastal region. The report generator may be any device that is adapted to place the data into a tangible medium, such as a printer, disc burner, flash memory, magnetic storage media, etc. The measurement device can be a photosensor, camera, digital camera and video camera, etc. The measurement device may be placed in any position from which it can sense the required light wavelengths, such as on a satellite, an aircraft, a buoy, a boat, a light house, or a handheld device. Any commercially available equipment for collecting and analyzing wavelength and geographic data can be used in the present invention.

### 5.3 ORGANISMS

The organisms useful in the invention include fishes and shellfishes. As used herein, the term fish refers to a member or a group of the following classes: Actinopteryii (i.e., ray-finned fish) which includes the division Teleosteri (also known as the teleosts), Chondrichytes (e.g., cartilaginous fish), Myxini (e.g., hagfish), Cephalospidomorphi (e.g., lampreys), and Sarcopteryii (e.g., coelacanths). The teleosts comprise at least 38 orders, 426 families, and 4064 genera. Some teleost families are large, such as Cyprinidae, Gobiidae, Cichlidae, Characidae, Loricariidae, Balitoridae, Serranidae, Labridae, and Scorpaenidae. In many embodiments, the invention involves bony fishes, such as the teleosts, and/or cartilaginous fishes. When referring to a plurality of organisms, the term “fish” is used interchangeably with the term “fishes” regardless of whether one or more than one species are present, unless clearly indicated otherwise. As used herein, the terms “shellfish” and “shellfishes” refers to various species of mollusks, crustaceans, and echinoderms that feed on planktons. The term “shellfish” is used herein as singular and plural interchangeably with the term “shellfishes” regardless of whether one or more than one species are present, unless clearly indicated otherwise.

In an aquatic environment, fish occupy various trophic levels, such as carnivores (e.g., piscivores), herbivores, planktivores, detritivores, and omnivores. Fishes that can be used in the present invention feed on algae, but it is not required that they feed exclusively on algae. Planktivores are preferably used. They can be planktivores that feed on both phytoplankton and zooplankton. Omnivores and herbivores can also be used to remove the algae. Many of the planktivores and omnivores are filter feeders. They can be pelagic filter feeders or benthic filter feeders. Many species of planktivores develop specialized anatomical structures to enable filter feeding, e.g., gill rakers and gill lamellae. Generally, the sizes of such structures relative to the dimensions of the plankton in the water affect the diet of a planktivore. Fish having more closing spaced gill rakers with specialized secondary structures to form a sieve are typically phytoplanktivores. Others having widely spaced gill rakers with secondary barbs are generally zooplanktivores. In the case of piscivores, the gill rakers are generally reduced to barbs. Gill lamellae are structures found in shellfishes adapted for filter feeding.

Gut content analysis can determine the diet of an organism used in the invention. Techniques for analysis of gut content of fish and shellfish are known in the art. As used herein, a planktivore is a phytoplanktivore if a population of the planktivore, reared in eutrophic water with non-limiting quantities of phytoplankton and zooplankton, has on average more phytoplankton than zooplankton in the gut. Under similar conditions, a planktivore is a zooplantivore if the population of the planktivore has on average more zooplankton than phytoplankton in the gut. Gut content analysis can also reveal the dimensions of the plankton ingested by the planktivore and the preference of the planktivore for certain species of algae. Knowing the average dimensions of ingested plankton, the preference and efficiency of the planktivore towards a certain size class of plankton can be determined. The size preference of a planktivore can be used to match the dimensions of algae in the eutrophic water. The species preference can also be used to match the dominant species of algae in the eutrophic water. Such information on the diet of a planktivore can be useful in choosing the plurality of planktivores to be deployed given the characteristics of the algae in a body of eutrophic water. By matching the preferred size range of algae and/or the species preference of a planktivore with the algae population in the water, the efficiency of the methods of the invention can be improved.

Many plankton feeders go through ontogenetic changes that include their feeding habits. The diet changes are associated with ontogenetic developments in eyesight, locomotion, mouth dimensions, dentition, and gut dimension. As feeding habits change when an organism hatches and grows from a larva into a juvenile, and then into an adult, it can change from one type of feeder to another, e.g., from a zooplanktivore to a phytoplanktivore, or from a phytoplanktivore to a zooplanktivore. It is contemplated that the efficiency of the methods of the invention can be improved by using planktivores of an age or ontogenetic form that matches the characteristics of the algae in the eutrophic water. For example, where the dimensions of a dominant species in the eutrophic water or the bloom species in an algal bloom, a harmful algal bloom or a hypoxic zone fall in one of the following ranges: from about 200 to 2000 μm, about 20 to 200 μm, about 2 to 20 μm, or about 0.2 to 2 μm, it would be advantageous to use planktivores that ingest efficiently or prefer plankton with similar dimensions.

Fishes that are used in the methods of the invention feed on algae, but it is not required that they feed exclusively on microalgae, i.e., they can be herbivores, omnivores, planktivores, phytoplanktivores, zooplanktivores, or generally filter feeders, including pelagic filter feeders and benthic filter feeders. In some embodiments of the invention, the population of fish useful for harvesting algae comprises predominantly planktivores. In some embodiments of the invention, the population of fish useful for harvesting algae comprises predominantly omnivores. In certain embodiments, one or several major species in the fish population are planktivores or phytoplanktivores. In certain mixed fish population of the invention, planktivores and omnivores are both present. In certain other mixed fish population, in addition to planktivores, herbivores and/or detritivores are also present. In certain embodiments, piscivores are used in a mixed fish population to harvest other fishes. In certain embodiments, piscivores are less preferred or excluded from the systems of the invention. The predominance of one type of fish as defined by their trophic behavior over another type in a population of fishes can be defined by percentage head count as described above for describing major fish species in a population (e.g., 90% phytoplanktivores, 10% ominivores).

Fishes useful for the invention can be obtained from fish hatcheries or collected from the wild. The fishes may be fish fry, juveniles, fingerlings, or adult/mature fish. By “fry” it is meant a recently hatched fish that has fully absorbed its yolk sac, while by “juvenile” or “fingerling” it is meant a fish that has not recently hatched but is not yet an adult. In certain embodiments of the invention, fry are used. In certain embodiments of the invention, juveniles that have metamorphosed are used. Any fish aquaculture techniques known in the art can be used to stock, maintain, reproduce, and gather the fishes used in the invention. Depending on the local environment and the type of fish used, the fish can be introduced at various densities from about 50 to 100, about 100 to 300, about 300 to 600, about 600 to 900, about 900 to 1200, and about 1200 to 1500 individuals per m².

One or more species of fish can be used to remove the algae in eutrophic water. In one embodiment of the invention, the population of fish comprises wild fishes, farmed fishes, and/or genetically improved fish. In another embodiment, the fish population is mixed and thus comprises one or several major species of fish including wild fish, farmed fish, and/or genetically improved fish. A major species is one that ranks high in the head count, e.g., the top one to five species with the highest head count relative to other species. In a preferred embodiment, at least one breed of genetically improved fish, considered a species in this context, is a major species in the population. The one or several major fish species may constitute greater than about 10%, about 20%, about 30%, about 40%, about 50%, about 60%, about 70%, about 75%, about 80%, about 90%, about 95%, about 97%, about 98% of the fish present in the population. In certain embodiments, several major fish species may each constitute greater than about 10%, about 20%, about 30%, about 40%, about 50%, about 60%, about 70%, or about 80% of the fish present in the population. In various embodiments, one, two, three, four, five major species of fish are present in a population. Accordingly, a mixed fish population or culture can be described and distinguished from other populations or cultures by the major species of fish present. The fish population or culture can be further described by the percentages of the major and minor species or the breed(s) of genetically improved fishes, or the percentages of each of the major species. It is to be understood that mixed cultures having the same genus or species may be different by virtue of the relative abundance of the various genus and/or species present.

Fish inhabit most types of aquatic environment, including but not limited to freshwater, brackish, marine, and briny environments. As the present invention can be practiced in any of such aquatic environments, any freshwater species, stenohaline species, euryhaline species, marine species, species that grow in brine, and/or species that thrive in varying and/or intermediate salinities, can be used. Fishes from tropical, subtropical, temperate, polar, and/or other climatic regions can be used. Fishes that live within the following temperature ranges can be used: below 10° C., 9° C. to 18° C., 15° C. to 25° C., 20° C. to 32° C. In one embodiment, fishes indigenous to the region at which the methods of the invention are practiced, are used. Preferably, fishes from the same climatic region, same salinity environment, or same ecosystem, as the algae are used. Most preferably, the algae and the fishes are derived from a naturally occurring trophic system.

Fishes from different taxonomic groups can be used in the methods of the invention. It should be understood that, in various embodiments, fishes within a taxonomic group, such as a family or a genus, can be used interchangeably in various methods of the invention. The invention is described below using common names of fish groups and fishes, as well as the scientific names of exemplary species. Databases, such as FishBase by Froese, R. and D. Pauly (Ed.), World Wide Web electronic publication, www.fishbase.org, version (06/2008), provide additional useful fish species within each of the taxonomic groups that are useful in the invention. It is contemplated that one of ordinary skill in the art could, consistent with the scope of the present invention, use the databases to specify other species within each of the described taxonomic groups for use in the methods of the invention.

In certain embodiments of the invention, the fishes used in the invention are in the order Acipeneriformes, such as but not limited to, sturgeons (trophic level 3) e.g., Acipenser species, Huso huso, and paddlefishes (plankton-feeder), e.g., Psephurus gladius, Polyodon spathula, and Pseudamia zonata.

In certain embodiments of the invention, the fishes used in the invention are in the order Clupiformes which include the following families: Chirocentridae, Clupeidae (menhadens, shads, herrings, sardines, hilsa), Denticipitidae, and Engraulidae (anchovies). Exemplary members within the order Clupiformes, i.e., the clupeids, include but are not limited to, the menhadens (Brevoortia species), e.g, Ethmidium maculatum, Brevoortia aurea, Brevoortia gunteri, Brevoortia smithi, Brevoortia pectinata, Gulf menhaden (Brevoortia patronus), and Atlantic menhaden (Brevoortia tyrannus); the shads, e.g., Alosa alosa, Alosa alabamae, Alosa fallax, Alosa mediocris, Alosa sapidissima, Alosa pseudoharengus, Alosa chrysochloris, Dorosoma petenense; the herrings, e.g., Etrumeus teres, Harengula thrissina, Pacific herring (Clupea pallasii pallasii), Alosa aestivalis, Ilisha africana, Ilisha elongata, Ilisha megaloptera, Ilisha melastoma, Ilisha pristigastroides, Pellona ditchela, Opisthopterusi tardoore, Nematalosa come, Alosa aestivalis, Alosa chrysochloris, freshwater herring (Alosa pseudoharengus), Arripis georgianus, Alosa chrysochloris, Opisthonema libertate, Opisthonema oglinum, Atlantic herring (Clupea harengus), Baltic herring (Clupea harengus membras); the sardines, e.g., Ilisha species, Sardinella species, Amblygaster species, Opisthopterus equatorialis, Sardinella aurita, Pacific sardine (Sardinops sagax), Harengula clupeola, Harengula humeralis, Harengula thrissina, Harengula jaguana, Sardinella albella, Sardinella janeiro, Sardinella fimbriata, oil sardine (Sardinella longiceps), and European pilchard (Sardina pilchardus); the hilsas, e.g., Tenuolosa species, and the anchovies, e.g., Anchoa species (A. hepsetus, A. mitchilli), Engraulis species, Thryssa species, anchoveta (Engraulis ringens), European anchovy (Engraulis encrasicolus), Australian anchovy (Engraulis australis), Engraulis eurystole, Setipinna phasa, and Coilia dussumieri.

In certain embodiments of the invention, the fishes used in the invention are in the superorder Ostariophysi which include the order Gonorynchiformes, order Siluriformes, and order Cypriniformes. Non-limiting examples of fishes in this group include milkfishes, catfishes, barbs, carps, danios, zebrafish, goldfishes, loaches, shiners, minnows, and rasboras. Milkfishes, such as Chanos chanos, are plankton feeders. The catfishes, such as channel catfish (Ictalurus punctatus), blue catfish (Ictalurus furcatus), catfish hybrid (Clarias macrocephalus), Ictalurus pricei, Pylodictis olivaris, Brachyplatystoma vaillantii, Pinirampus pirinampu, Pseudoplatystoma tigrinum, Zungaro zungaro, Platynematichthys notatus, Ameiurus catus, Ameiurus melas are detritivores. Carps are freshwater herbivores, plankton and detritus feeders, e.g., common carp (Cyprinus carpio), Chinese carp (Cirrhinus chinensis), black carp (Mylopharyngodon piceus), silver carp (Hypophthalmichthys molitrix), bighead carp (Aristichthys nobilis) and grass carp (Ctenopharyngodon idella). Shiners include members of Luxilus, Cyprinella and Notropis genus, such as but not limited to, Luxilus cornutus, Notropis jemezanus, Cyprinella callistia. Other useful herbivores, plankton and detritus feeders are members of the Labeo genus, such as but not limited to, Labeo angra, Labeo ariza, Labeo bata, Labeo boga, Labeo boggut, Labeo porcellus, Labeo kawrus, Labeo potail, Labeo calbasu, Labeo gonius, Labeo pangusia, and Labeo caeruleus.

In certain embodiments of the invention, the fishes used in the invention are in the superorder Protacanthopterygii which include the order Salmoniformes and order Osmeriformes. Non-limiting examples of fishes in this group include the smelts and galaxiids (Galaxia species). Smelts are planktivores, for example, Spirinchus species, Osmerus species, Hypomesus species, Bathylagus species, Retropinna retropinna, and European smelt (Osmerus eperlanus).

In certain embodiments of the invention, the fishes used in the invention are in the superorder Acanthopterygii which include the order Mugiliformes, Pleuronectiformes, and Perciformes. Non-limiting examples of this group are the mullets, e.g., striped grey mullet (Mugil cephalus), which include plankton feeders, detritus feeders and benthic algae feeders; the cichlids, the gobies, the gouramis, mackerels, perches, scats, whiting, snappers, groupers, barramundi, drums, wrasses, and itilapias (Oreochromis sp.). Examples of tilapias include but are not limited to nile tilapia (Oreochromis niloticus), red tilapia (O. mossambicus x O. urolepis hornorum), and mango tilapia (Sarotherodon galilaeus).

In certain embodiments of the invention, some or all species of carps, tilapias, trouts, and salmons are excluded or less preferred. When the invention is practiced in the Gulf of Mexico using one or more of the following species of fishes: Brevoortia species such as B. patronus and B. tyrannus, Hyporhamphus unifasciatus, Sardinella aurita, Adinia xenica, Diplodus holbrooki, Dorosoma petenense, Lagodon rhombodides, Microgobius gulosus, Mugil species such as Mugil cephalus, Mugil cephalus, Mugil curema, Sphoeroides species such as Sphoeroides maculatus, Sphoeroides nephelus, Sphoeroides parvus, Sphoeroides spengleri, Aluterus schoepfi, Anguilla rostrata, Arius felis, Bairdella chrysoura, Bairdeiella chrysoura, Chasmodies species such as Chasmodes saburrae and Chasmodies saburrae, Diplodus holbrooki, Heterandria formosa, Hybopsis winchelli, Ictalurus species such as Ictalurus serracantus and Ictalurus punctatus, Leiostomus xanthurus, Micropogonias undulatus, Monacanthus ciliatus, Notropis texanus, Opisthonema oglinum, Orthopristis chrysoptera, Stephanolepis hispidus, Syndous foetens, Syngnathus species such as Syngnathus scovelli, Trinectes maculatus, Archosargus probatocephalus, Carpiodes species such as C. cyprinus and C. velifer, Dorosoma cepedianum, Erimyzon species such as Erimyzon oblongus, Erimyzon sucetta, and Erimyzon tenuis, Floridichthys carpio, Microgobius gulosus, Monacanthus cilatus, Moxostoma poecilurum, and Orthopristis chrysophtera.

The shellfishes used in the methods of the invention are preferably sedentary shellfishes, such as bivalves. Depending on the aquatic environment, freshwater, brackish water, or marine shellfishes can be used. The shellfishes of the invention include but are not limited to oysters, mussels, scallops, clams, and more particularly, Crassostrea species such as C. gigas, C. virginica, C. ariakensis, C. rivularis, C. angulata, C. eradelie, C. commercialis, Saccostrea species such as S. glomerata, S. cucculata and S. commercialis; Mercenaria species such as M. mercenaria and M. campechensis; Ostrea species such as O. edulis, O. chilensis, and O. lurida, Area transversa, Panope generosa, Saxodomus nuttili; Mytilus species such as M. edulis (blue mussel), M, coruscus, M. chilensis, M. trossulus, and M. galloprovincialis (Mediterranean mussel), Aulacomya ater, Choromytilus chorus, Tapes semidecussatus; Perna species such as P. viridis, P. canaliculus; Venerupis species such as V. decussata, V. semidecussata, Sinonovacula constricta (Razor clam), Mya arenaria (soft shell clams), Spisula solidissima (surf clams), Amusium balloti, Argopecten irradians (bay scallops); Pectan species such as P. alba, P. yessonsis, P. maximus; and Chlamys species such as C. farreri, C. opercularis, C. purpuratus and C. varia.

In many embodiments of the invention, shellfishes and fishes are both cultured within the same body of eutrophic water and in certain embodiments, in proximity to each other, or in the same enclosure.

### 5.4 ENCLOSURES

The planktivorous organisms are confined to the systems of the invention in eutrophic water such that they can feed on the algae. Some systems of the invention are designed to facilitate easy harvesting and transportability. As used herein, the term “enclosure” includes any form of physical confinement of the organisms in water that allows exchange of water that comprises plankton between the inside and outside of the enclosure, wherein the organisms grow by feeding on the plankton in the water. An enclosure can be a floating, submersible, or submerged structure. Non-limiting examples of an enclosure include a cage, a net, a barricade for an area, a porous container, a substrate to which shellfishes are attached, and a compartment on board of a vessel.

In one embodiment of the invention, the enclosure is moored at a fixed location where local tides and currents provide natural water exchange. In another embodiment, the enclosure is one that can be relocated from one location to another. In another embodiment, the enclosure is free-floating and follows local currents. In another embodiment, the enclosure is free-floating but moved by mechanical propulsion, such as a boat engine. The relocation of an enclosure depends on the nutrient level of the eutrophic water, the density of algal biomass, the oxygen level, weather, and other factors, and can be performed on an ad hoc basis or seasonally. The enclosure can comprise various environmental monitoring systems as well as systems for supplemental feeding and aeration, and for moving the enclosure horizontally and/or vertically in water. Flow of water through an enclosure facilitates gas exchange, removal of waste products, and replenishment of plankton. The flow can be generated by wind, wave, tide, or other natural movement of the water, or it can be caused by various means known in the art, including but not limited to the use of fluid pumps, paddles, movement of the cage, power-assisted aeration, etc. Optionally, the volume of flow, the flow rate, and the direction of flow either in or out or both in and out of an enclosure, can be regulated. In one embodiment, the enclosure with its planktivorous organisms are moved continuously through the water. In another embodiment, the water is caused to move through a stationary enclosure. In either case, the enclosure is replenished with algae and oxygen from the outside. Many of the commercially available enclosures for aquaculture can be used in accordance with the methods of the invention. Minor adaptations of existing enclosures, if required, can be performed by one of skill in the art with routine experimentation.

A cage is a meshed structure wherein the mesh can be flexible (e.g., nets) or rigid. The mesh can be made of natural and/or synthetic materials, such as cotton, bamboo, wood, reeds, nylon and other plastics (e.g., polyamide, polypropylene, polyethylene, fiberglass), and metals (e.g., galvanized steel). Many of the materials are commercially available. In one embodiment, the cages comprise a mesh, such as a net bag, supported by structures that are secured to the bottom of the water. The mesh size is selected in accordance with the dimensions of the planktivorous organisms in the enclosure and the dimensions of potential predators. The cages are designed to prevent escape of the planktivorous organisms, and intrusion or access by predatory organisms, such as piscivorous fishes, crustaceans, mammals (e.g., seal), and birds. Floating and submersible cages generally comprise a buoyant collar or frame to which a mesh is attached. Some floating cages comprise a collar that rotates about a central axis, while others rotate by moving floatation elements or by adjusting the buoyancy of the frame members. Submersible cages can be kept at surface during calm weather and are lowered into the water during storms. Submerged cages are constantly underwater and anchored to the bottom. Enclosures can be grouped together depending on the scale of the operation, enclosure design and mooring constraints imposed by the environment. A group of enclosures can share environmental monitoring systems, data systems, and guidance systems of the invention.

In certain embodiments, the enclosure is a substrate to which bivalves attach themselves and the substrate, which can be a cage, does not necessarily envelope the bivalves. Umbrella culture uses shellfishes that have been attached to ropes and suspended from a central post radiating to anchors like spokes on a wheel, thus taking the shape of an umbrella. Rack culture is accomplished by constructing racks of treated lumber, steel rebar, or concrete blocks. Ropes, sticks, or nylon mesh bags with shellfishes attached or contained are placed on the racks for growout. Techniques for shellfish culture are well known in the art and can be adapted to the methods of the invention without undue experimentation. For example, the bottom technique involves scattering on the bottom of the water spat-laden cultch. Stake culture involves attaching spat-laden shells to bamboo, wooden, cement, or PVC pipe stakes and driving the stakes into the bottom or laid out horizontally. Spat may be allowed to settle directly on the stakes. This technique is particularly useful in areas with soft bottoms that would not allow bottom culture. The mesh bag technique is used quite extensively in areas that are too shallow for raft culture and too soft for bottom culture. Raft culture incorporates floating structures to suspend shellfishes off the bottom. The rafts can be made of logs, bamboo, Styrofoam, or 55-gallon drums. Raft materials are lashed together to allow flexing with wave action. Rafts are anchored to the bottom securely. Strings, ropes, nets (pearl nets, lantern nets), trays, and bags of shellfishes are suspended below the raft. The long line technique also involves suspending shellfishes off the bottom, wherein spat-laden cultch are attached to polypropylene rope and strung between wooden, metal, or PVC plastic stakes inserted into the substrate. Other techniques known in the art can also be applied, see, for example, U.S. Pat. Nos. 3,811,411; 4,896,626; 5,511,514; and 5,836,266.

Any methods known in the art can be used to moor an enclosure or a group of enclosures by a physical link to a fixed point on the seabed or to a fixed structure erected in water. In certain embodiment, the fixed structure is an installation for offshore oil and/or gas exploration and production, e.g., decommissioned platforms, to which the enclosures of the invention are tethered. The disclosures of copending U.S. provisional patent application No. 61/159,367, filed Mar. 11, 2009, are incorporated herein by reference in their entirety. The fixed structure erected in water can form a part of a cage. In another embodiment, mobile enclosure, such as a towable cage is used. Transportable or towable cages can be attached to any vessel, such as a trawler or a barge, and be towed from one location to another. The methods of the invention also provide the use of towable cages where the cages comprising the planktivorous organisms are towed continuously thorough water within an eutrophic zone to ensure a plentiful supply of planktons for the caged planktivorous organisms. The movement of the cage through water also generate a water flow through the cage that facilitates aeration of the cage and dilution of waste products. The course of the vessel and the towed cage(s) can be steered towards areas of high primary productivity by a guidance system that receives signals generated by the data systems of the invention which gather and integrate remote sensing data and/or water quality information. Accordingly, the enclosures of the invention can comprise a guidance system which receives signals from the data systems. In yet another embodiment, the enclosure is inside a vessel, e.g., a compartment of a modified tanker or barge, wherein water is allowed into and out of the compartment at various time. A non-limiting example of a mechanism for water exchange is via the ballast tank of a vessel.

### 6. BIOFUEL AND FISH MEAL PRODUCTION

The planktivorous fishes used in the methods of the invention can be set free in a body of water, or used for a variety of purposes, including but not limited to, production of food, fishmeal, biofuel, and oleochemical products. Any fish processing technologies known in the art can be applied to obtain lipids from the fishes grown in and harvested from eutrophic water. For example, the fishes are subjected to gentle pressure cooking and pressing, which coagulates the protein, ruptures the fat deposits and liberates lipids and oil and physicochemically bound water; and pressing the coagulate by a continuous press with rotating helical screws. The coagulate may alternatively be centrifuged. This step removes a large fraction of the liquids (press liquor) from the mass, which comprises an oily phase and an aqueous fraction (stickwater). The separation of press liquor can be carried out by centrifugation after the liquor has been heated to 90° C. to 95° C. Separation of stickwater from oil can be carried out in vertical disc centrifuges. The lipids in the oily phase (fish oil) may be polished by treating with hot water which extracts impurities from the lipids to form biofuel. To obtain fish meal, the separated water is evaporated to form a concentrate (fish solubles) which is combined with the solid residues, and then dried to solid form (presscake). The dried material may be grinded to a desired particle size. The fish oil or a composition comprising fish lipids, can be collected and used as a biofuel, or upgraded to biodiesel or other forms of energy feedstock.

Examples of systems and methods for processing lipids such as fish lipids into biofuel, can be found in the following patent publications, the entire contents of each of which are incorporated by reference herein: U.S. Patent Publication No. 2007/0010682, entitled “Process for the Manufacture of Diesel Range Hydrocarbons;” U.S. Patent Publication No. 2007/0131579, entitled “Process for Producing a Saturated Hydrocarbon Component;” U.S. Patent Publication No. 2007/0135316, entitled “Process for Producing a Saturated Hydrocarbon Component;” U.S. Patent Publication No. 2007/0135663, entitled “Base Oil;” U.S. Patent Publication No. 2007/0135666, entitled “Process for Producing a Branched Hydrocarbon Component;” U.S. Patent Publication No. 2007/0135669, entitled “Process for Producing a Hydrocarbon Component;” and U.S. Patent Publication No. 2007/0299291, entitled “Process for the Manufacture of Base Oil.”

### 7. PREFERRED EMBODIMENTS

In a preferred embodiment, the planktivorous organism is menhaden. Menhaden is in the Clupiformes order and is representative of a large group of schooling fish that are primarily planktivores and that include but are not limited to the clupeids, sardines, anchovies, shads, herrings, pilchards, and hilsas.

Gulf menhaden Brevoortia patronus and Atlantic menhaden Brevoortia tyrannus are considered particularly suitable for use in the present invention in the Eastern shores of North America and the Gulf of Mexico, respectively. These fishes are pelagic filter feeders possessing a filtering apparatus consisting of gill rakers which strain plankton from the water and an epibranchial organ which concentrates the food accumulated on the rakers. Menhaden are commercially caught but not farmed, and the landings and wild stocks are monitored by government fishery management agency (1991, Vaughan and Merriner, Mar Fisheries Rev 53:49-57). In the wild, Atlantic menhaden abundance is correlated with abundance of microflagellates, diatoms, chlorophyll a, and shows a preference for larger phytoplankton. Prorocentrum blooms tend to correlate positively with distribution of Atlantic menhaden in North Carolina and Virginia estuarine creeks (1989, Friedland et al., Mar Ecol Prog Ser 54:1-11). Post-metamorphic juvenile Atlantic menhaden modify their distribution patterns to follow those of phytoplankton biomass distribution. Location of juvenile nurseries in North Carolina estuary is believed to be influenced by phytoplankton abundance (1996, Friedland et al., Estuaries 19:105-114). The geographic distribution of menhaden coincides with coastal areas where algal bloom and hypoxic zones occur.

The physiology and behavior of the menhaden are well known. Gulf and Atlantic menhaden have similar developmental stages: larvae at <21 mm S.L., post-larvae at 21-30 mm, juvenile at >30 mm, and young adult at >85 mm. Atlantic menhaden achieve these stages earlier than Gulf menhaden (1993, Powell, Fishery Bulletin 91:119-128). Juvenile, young adult, or adult menhaden with gill rakers that are formed after metamorphosis, are preferably used in the methods of the invention. Depending on the age of the fish, different types of phytoplankton and zooplankton with dimensions ranging from about 13 μm up to about 10 mm have been retained. Swimming speed is a behavioral response to the size and abundance of food particles present and is constant over a wide range of phytoplankton concentration (1975, Durbin and Durbin, Mar Biol. 33:265-277). A direct relationship of increased growth and larger size of juvenile Atlantic menhaden with food supply has been demonstrated in nutrient-enriched laboratory mesocosms with the highest values achieved in silicate-enhanced diatom-containing tanks (1990, Keller et al., Limnol. Oceangr. 35:109-122). The changes in body composition and morphology of young-of-the-year gulf menhaden in Louisiana has been studied. The lipid content of gulf menhaden varied from 0 to 8%, with juveniles at 2.7% and young adults at 3.5%. The energy content of the fish relates primarily to lipid content at about 22.1 kJ/g to 27.4 kJ/g (1986, Deegan, J Fish Biol. 29:403-415). The fatty acid composition of menhaden oil have been extensively analyzed by Joseph (1985, Mar Fisheries Rev., 47:30-37).

Research-based methods for handling menhaden are known in the art. For example, methods for artificial fertilization of gulf menhaden and cross-fertilization with yellowfin menhaden (B. smithi) are reported (1968, Hettler Jr., Trans. Am. Fisheries Soc. 97:119-123). Methods for transporting adult and larval gulf menhaden and techniques for spawning in the laboratory are also reported (1983, Hettler, The Progressive Fish Culturist, 45:45-48). It is contemplated that such husbandry and culturing techniques can be adapted with routine experimentation, for use in the practice of the invention.

Given the knowledge of the feeding behavior, bioenergetics, and lipid composition of menhaden, the inventors are using menhaden in eutrophic water for reduction of algal biomass, production of biofuels and fish meal. Methods for handling menhaden can be adapted for use with other fishes, e.g., clupeid fishes.

### 7.1 MENHADEN CULTURE

In this example, at a laboratory scale, menhaden from the Gulf of Mexico were raised in indoor tanks to consume cultured algae that are native to the Texas Gulf coast, and the results were used to initiate a pilot operation involving about 1000 menhaden in an open pond near Rio Hondo, Tex. Menhaden are generally abundant in the Gulf, and have never been cultured for aquaculture purpose. Many species of algae native to the Texan Gulf coast are known to be involved in algal bloom.

One of the challenges of culturing phytoplanktivorous fish is providing algae that are sufficiently large for the fish to retain in its filter. Durbin and Durbin (1975, Grazing rates of the Atlantic menhaden I as a function of particle size and concentration, Marine Biol. 33:265-277) reported that the size threshold for the Atlantic menhaden (Brevoortia tyrannus) is 13-16 p.m. Diatoms collected from ponds in Texas that can be cultured in the laboratory are typically smaller (<10 μm) with a notable exception which is a strain in the genus Amphiprora that is approximately 20 μm.

In the laboratory tests, small cohorts (10-15 fish) of age 0 menhaden, including both species of Brevoortia gunteri (Gulf menhaden) and Brevoortia patronus (fine scale Gulf menhaden), were allowed to feed on algae that are native to the Texas Gulf Coast, including strains of Isochrysis (4-6 μm in size), Chaetoceros (6-8 μm) and Amphiprora (20 μm). On average, the menhaden were approximately 65-70 mm in length and weighed about 5 g. Both species are indigenous to the Gulf Coast, phytoplanktivorous in its feeding habit, and efficient accumulators of lipids. The size of the algae was measured by a Beckman Coulter Counter (Multisizer-3). The algae were initially taken from ponds at Rio Hondo, isolated in a laboratory, and were then mass-cultured in 80-liter photobioreactors. The algae were selected for a combination of larger size, fast reproduction rate (doubling every 2-3 days), and higher lipid content (10-18%). The experiments were performed in duplicate in 140-liter tanks each containing 10-15 fish. Approximately 20 liters of green water (100-400 mg/L algae from photobioreactors) were added to the tanks and the algae concentration was monitored with the Coulter Counter. A third tank was used as a control. The menhaden effectively filter-fed on the Chaetoceros and Amphiprora, clearing 80-100% of the algae over 24 hrs, and easily consumed 5-10% of their body weight daily in algae (dry weight basis). However, the menhaden did not consume the Isochrysis.

In the pilot operations, several 5-acre unlined pond near Rio Hondo were prepared by removing existing large vegetation, such as bushes, and plowing into the ground smaller vegetation, such as grasses, weeds. The ground was tilled to allow bacterial decomposition of the biomass at the bottom of the ponds. The ponds were then filled with saline water. Water salinity at Rio Hondo varies seasonally from 10 to 17 parts per thousand depending mostly on rainfall. The water was coarsely screened by 1 mm filter to remove debris and aquatic organisms, such as fish. The native consortium of microalgae served as the initial inoculum for the ponds.

A mixed population of B. gunteri and B. patronus comprising approximately one thousand menhaden (year 0) were cultured in three 5-acre ponds for eight weeks. The population of menhaden filter-fed on the natural algal bloom that was induced by inorganic fertilizers (urea and mono-ammonium phosphate) in one pond and by organic fertilizers (pelletized fish feed via fish waste or uneaten feed) in another pond. The fish grew from an average of 5 g to 16 g and from 70 mm to 110 mm in eight weeks with minimal mortality (<5% of population). The growth rate obtained was comparable to that of wild Gulf menhaden as reported in Vaughan, D. S., Smith, Joseph W., and Prager, Michael H. (2000), “Population Characteristics of Gulf Menhaden, Brevoortia patronus.” NOAA Technical Report NMFS 149. The results show that menhaden can be maintained in culture and be ready for deployment to reduce the algal biomass in the waters off the Texas Gulf coast.

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only, and the invention is to be limited only by the terms of the appended claims along with the full scope of equivalents to which such claims are entitled.

1. A method for reducing algal biomass in a body of eutrophic water, said method comprising introducing a plurality of fishes that feed on algae to a body of eutrophic water, and culturing the fishes in the eutrophic water, wherein the fishes are confined, wherein the fishes feed on the algae, thereby reducing the algal biomass, and wherein the fishes are harvested to produce biofuel, specialty chemicals, nutraceuticals, food, and/or fish meal.

2. The method of claim 1, wherein the body of eutrophic water comprises more than of 1×10⁵ algal cells per ml, and the algal cells are cells of cyanobacteria, diatoms, dinoflagellates, raphidophytes, and/or haptophytes.

3. The method of claim 1, wherein the body of eutrophic water comprises an algal bloom, a harmful algal bloom, or a hypoxic zone; or wherein the body of eutrophic water is found in a location where an algal bloom, a harmful algal bloom, or a hypoxic zone has occurred previously.

4. The method of claim 1, wherein the dimensions of at least one dominant species of algae range from about 200 to 2000 μm, 20 to 200 μm, about 2 to 20 μm, or about 0.2 to 2 μm.

5. The method of claim 1, wherein at least one dominant species in the eutrophic water is a species of Anabaena, Aphanizomenon, Microcystis, Noctiluca, Alexandrium, Prorocentrum, Gymnodinium, Ceratium, Pfiesteria, Dinophysis, Gyrodinium, Heterosigma, Chattonella, Skeletonema, Synedropsis, Pseudonitzschia, Leptocylindrus, Chaetoceros; Phaeocystis, Nannochloris, Stichococcus, Aureococcus, Miraltia, Guinardia, Spermatozopsis, Urosolenia, Nitschia, Cyclotella, Cryptomonas, or Pedinophora.

6. The method of claim 1, wherein the fishes are confined to an enclosure.

7. The method of claim 1, wherein the plurality of fishes comprises planktivores and/or omnivores.

8. The method of claim 7, wherein at least one of the major species of planktivores is a pelagic phytoplanktivore.

9. The method of claim 1, wherein at least one major species of the fishes that feed on algae is a species of fish in the order Clupiformes, Siluriformes, or Cypriniformes.

10. The method of claim 1, wherein the plurality of fishes comprise at least one of any one of menhaden, anchovies, shads, sardines, pilchards, herring, smelts, catfish, milkfish, carps, mullets, and hilsa.

11. (canceled)

12. The method of claim 6, wherein the enclosure is a floating cage, a submersible cage, a submerged cage, or a towable cage.

13. The method of claim 1, wherein the plurality of fishes comprise Brevoortia patronus or Brevoortia iyrannus which are confined to a floating cage.

14. The method of claim 1, wherein the plurality of fishes are introduced at a density of 300 to 600, or 600 to 900 individuals per m².

15. The method of claim 6, wherein the step of culturing the plurality of fishes comprises replenishing the eutrophic water in the enclosure with algae, and does not comprise adding fish meal, fish oil, nitrogenous fertilizer, and/or phosphorous fertilizer into the eutrophic water.

16. The method of claim 6, wherein the step of culturing the plurality of fishes comprises maintaining the level of dissolved oxygen in the eutrophic water in the enclosure above 3 mg per liter.

17. The method of claim 6, wherein culturing the plurality of fishes comprises mixing eutrophic water from outside the enclosure with the eutrophic water in the enclosure.

18. The method of claim 6, wherein the step of culturing the plurality of fishes comprises moving the enclosure in the body of eutrophic water.

19. The method of claim 1, said method further comprises harvesting at least one of the plurality of fishes after culturing.

20. The method of claim 19, wherein said steps of introducing, culturing, and harvesting the plurality of fishes are repeated at least once or until the algal biomass is reduced.

21. A method for producing biofuel and/or fish meal, said method comprising introducing a plurality of fishes that feed on algae to a body of eutrophic water, wherein the fishes are confined, culturing the fishes in the eutrophic water where the fishes feed on the algae, harvesting the fishes, and processing the harvested fish to produce biofuel, specialty chemicals, nutraceuticals, food, and/or fish meal.

22. A system for reducing algal biomass in a body of eutrophic water, said system comprising a plurality of fishes that feed on algae in a body of eutrophic water, wherein the plurality of fishes are confined in the body of eutrophic water, and wherein the fishes are harvested to produce biofuel, specialty chemicals, nutraceuticals, food, and/or fish meal.

23-24. (canceled)

25. The system of claim 22, further comprising an environmental monitoring system, a data system, a guidance system, or a fish processing facility.

26. The method of claim 21, wherein the fishes are confined to an enclosure.

27. The system of claim 22, wherein the fishes are confined to an enclosure.

28. The system of claim 27, wherein the enclosure is a floating cage, a submersible cage, a submerged cage, or a towable cage.

29. The system of claim 27, wherein the enclosure is tethered to a vessel, inside a vessel, or tethered to an oil/gas production platform.
